(19) United States
(12) Patent Application Publication
(10) Pub. No.: US 2017/0177378 A1
(43) Pub. Date: Jun. 22, 2017

(54) METHOD OF SETTING HOT KEY AND METHOD OF CAPTURING SCREEN IMAGE

(71) Applicants: Inventec (Pudong) Technology Corporation, Shanghai (CN); INVENTEC CORPORATION, Taipei City (TW)

(72) Inventors: Ting-Ting CHEN, Shanghai (CN); Ze-Long MI, Shanghai (CN)

(21) Appl. No.: 15/058,029

(22) Filed: Mar. 1, 2016

(30) Foreign Application Priority Data
Dec. 17, 2015 (CN) 201510954181.6

(51) Int. Cl. G06F 9/44

(52) U.S. Cl. CPC G06F 9/4411

(57) ABSTRACT

A method of setting hot key includes: triggering an RBSU setting procedure in a system code interface of a BIOS of the computing apparatus, executing the RBSU setting procedure to enter an RBSU setting interface, registering a captured hot key in the RBSU setting interface and establishing a screen image procedure code with respect to the captured hot key. A method of capturing a screen image for applying the foregoing method in a RBSU executing interface includes: triggering an RBSU executing procedure under the system code interface, executing the RBSU executing procedure to enter the RBSU executing interface, determining if the captured hot key is triggered in the RBSU executing interface, executing the screen image procedure code to capture a screen image of the RBSU executing interface if positive, and storing the screen image into a storage apparatus electrically coupled with the computing apparatus.

### BACKGROUND OF INVENTION

1. Field of the Invention

The invention relates to a method of setting a hot key and a method of capturing a screen image, and more particularly to the method of setting a hot key and the method of capturing a screen image that firstly set a hot key for capturing screen images and further apply the hot key to capture a specific screen image.

2. Description of the Prior Art

As the technology progresses day by day, the development in networking has made various electronic products as indispensable tools in people's lives. From individual person to the enterprise, it is already the life to have desktop or portable computers as personal tool for handling business or private affairs. With the help of networking, electronic business, even across nations, has become casual activities everywhere. Facilities to construct the network require mainly the servers, and now the servers have been widely applied in the control centers of the majority of internet service providers (ISP).

Generally speaking, while in operating the server, if a resetting is required for correcting any kind of errors, a basic input/output system (BIOS) is performed firstly. Further, an operational interface for a ROM-based setup utility (RBSU) under the BIOS is then executed. Currently, parameters for the RBSU executing interface shall be stored manually by photographing through a mobile phone, a tablet computer or an electronic unit of a digital camera so as to record these parameters for future calibrations according in the same or another server. However, since such a recording means is practically cumbersome and has a higher risk to leak during a transmission, thus an improvement thereupon is definitely welcome to the art.

### SUMMARY OF THE INVENTION

In view of current technology in preserving the parameters by electronic photographing, the risk of information leakage and the cumbersome operation for recording the parameters are inevitable. Accordingly, it is the primary object of the present invention to provide a method of setting a hot key and a method of capturing a screen image, each of which registers and captures a hot key in the RBSU setting interface, and then corresponding program code with respect to the hot key is established, so that, in the following operations, the hot key can be directly triggered to capture the screen image of the RBSU executing interface.

Accordingly, it is the primary object of the present invention to provide a method of setting a hot key for capturing a screen image to be operated in a computing apparatus. The method of setting a hot key includes the steps of: (a) triggering an RBSU setting procedure in a system code interface of a BIOS of the computing apparatus; (b) executing the RBSU setting procedure so as to enter the RBSU setting interface; and, (c) in the RBSU setting interface, registering a captured hot key, and establishing a screen image procedure code with respect to the captured hot key in a BIOS code of the BIOS.

In one embodiment of the present invention, the computing apparatus is one of a server and a computer. Also, in the Step (a), an embedded application program of the BIOS is executed to trigger the RBSU setting procedure.

In one embodiment of the present invention, the Step (a) further includes a Step (a1) of triggering the RBSU setting procedure while the BIOS determines that a trigger hot key is triggered. Also, the system code interface of the BIOS has a trigger hot-key procedure code corresponding to the trigger hot key so as to execute the Step (a1) of triggering the RBSU setting procedure while the trigger hot-key procedure code is read.

In the present invention, a method of capturing a screen image is to apply the aforesaid method of setting a hot key in an RBSU executing interface so as to operate the computing apparatus. The method of capturing a screen image includes the steps of: (a) triggering an RBSU executing procedure under the system code interface of the BIOS of the computing apparatus; (b) executing the RBSU executing procedure so as to enter the RBSU executing interface; (c) determining if the captured hot key is triggered or not in the RBSU executing interface; (d) if a result of the Step (c) is positive, executing the screen image procedure code so as to capture a screen image of the RBSU executing interface; and, (e) storing the screen image into a storage apparatus electrically coupled with the computing apparatus.

In one embodiment of the present invention, the computing apparatus is one of a server and a computer, and the storage apparatus is one of a hard disk and a USB drive. While the storage apparatus is the USB drive, prior to the Step (a), a Step (a0) of electrically coupling the USB drive to the computing apparatus is included.

In one embodiment of the present invention, in the Step (c), a polling procedure is used to determine if the captured hot key is triggered or not.

By providing the method of setting a hot key and capturing a screen image, since the hot key can be captured and then set for the user to trigger in the future usage, thus the user needn't to introduce electronic devices for photographing the screen image of the RBSU executing interface. On the other hand, the screen image is directly captured by directly triggering the captured hot key. Hence, convenience in practical application is significantly improved, and also possible information leakage is substantially reduced.

All these objects are achieved by the method of setting a hot key and the method of capturing a screen image described below.

### BRIEF DESCRIPTION OF THE DRAWINGS

The present invention will now be specified with reference to its preferred embodiment illustrated in the drawings, in which:

FIG. 1 is a flowchart of the preferred method of setting a hot key in accordance with the present invention;

FIG. 2 is a schematic view of the system code interface of FIG. 1,

FIG. 3 is a schematic view of the RBSU setting interface of FIG. 1,

FIG. 4 is a schematic view of the RBSU executing interface of FIG. 1;

FIG. 5 is a flowchart of the preferred method of capturing a screen image in accordance with the present invention; and

FIG. 6 is a flowchart of another method of capturing a screen image in accordance with the present invention.

### DESCRIPTION OF THE PREFERRED EMBODIMENT

The invention disclosed herein is directed to a method of setting a hot key and a method of capturing a screen image. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Since various embodiments can be provided for the method of setting a hot key and the method of capturing a screen image in accordance with present invention, however, only single preferred embodiments for the method of setting a hot key and the method of capturing a screen image are raised herein for concise explanation for the present invention, and details for other embodiments would be omitted herein.

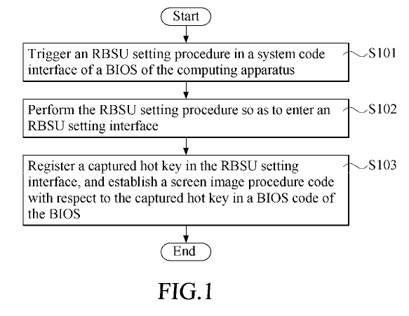

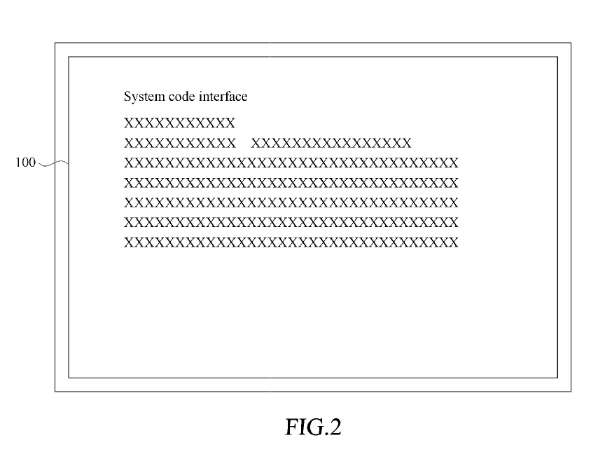

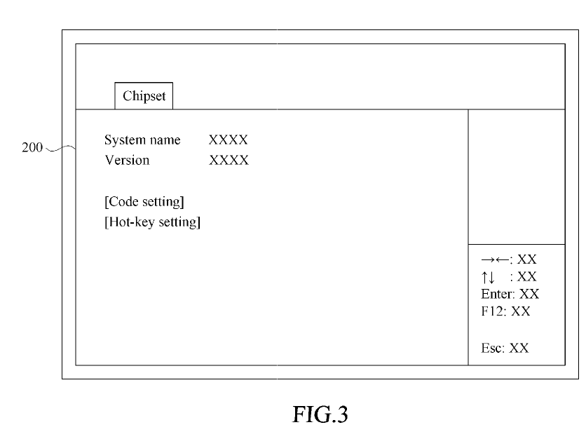

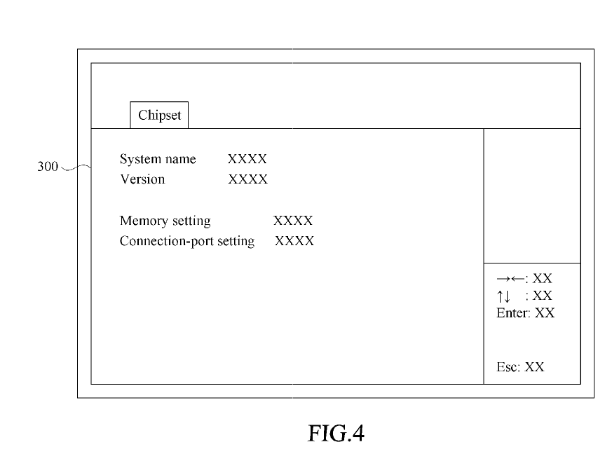

Refer now to FIG. 1 to FIG. 4; where FIG. 1 is a flowchart of the preferred method of setting a hot key in accordance with the present invention, FIG. 2 is a schematic view of the system code interface of FIG. 1, FIG. 3 is a schematic view of the RBSU setting interface of FIG. 1, and FIG. 4 is a schematic view of the RBSU executing interface of FIG. 1. As shown, the preferred method of setting a hot key in accordance with the present invention is provided to operate a computing apparatus, in which the computing apparatus can be one of a server and a computer (a desktop computer, a notebook computer and the like). In the preferred embodiment, the server is raised for a typical example. In the present invention, the method of setting a hot key includes the following steps.

Step S101: In a system code interface of a BIOS of the computing apparatus, trigger an RBSU setting procedure.

Step S102: Perform the RBSU setting procedure so as to enter an RBSU setting interface.

Step S103: Register a captured hot key in the RBSU setting interface, and establish a screen image procedure code with respect to the captured hot key in a BIOS code of the BIOS.

In Step S101, the system code interface 100, as shown in FIG. 2, can be the system code interface of the BIOS while the server is started up, and can, but not limited to, be embodied as the ordinary testing procedure (a power-on self-test POST) for starting the server.

In addition, in Step S101, in triggering the ROM-based setup utility (RBSU) setting procedure, either automatic triggering or manual triggering and by having the automatic triggering as a typical example, an embedded application program of the BIOS is performed to trigger the RBSU setting procedure and so as to write the embedded application program (APP for example) into the system executing code of the operating BIOS, such that, during the startup of the server, the embedded application program can be automatically executed while in running the power-on self-test so as to automatically trigger the RBSU setting procedure.

On the other hand, taking manual triggering method for example, Step S101 can further include a step of triggering the RBSU setting procedure in the case that the BIOS judges that a trigger hot key is triggered. Namely, this Additional step is to trigger the RBSU setting procedure through the built-in trigger hot key such as the F10 key or other trigger hot keys. The setting method can be performed as: if a trigger hot-key procedure code (i.e. the program code) is built in the system code interface of the BIOS (i.e. the BIOS code; or alternatively, the system code under the system code interface) with respect to the trigger hot key, and so while in reading the trigger hot-key procedure code (for example, while in executing the BIOS, a management module such as a central processor in the computing apparatus receives the trigger hot key, and further the management module reads the trigger hot-key procedure code), then perform the aforesaid trigger RBSU setting procedure. Namely, the method is to further add the trigger hot-key procedure code into the BIOS code so as to allow the user to utilize the hot key to trigger the RBSU setting procedure. However, in some other embodiments, it may directly input a code of

“EFI_SIMPLE_TEXT_INPUT_EX_PROTOCOL.RegisterKeyNotify( )” to enter the RBSU setting interface 200.

In Step S102, after the RBSU setting procedure is triggered, the RBSU setting procedure is automatically executed so as to enter the RBSU setting interface 200. In this RBSU setting interface 200, relative parameters for operating the server can be set. It shall be understood that parameters in FIG. 3 is only part of many parameters for the server, and is shown for an exemplary purpose. In practice, the RBSU setting interface 200 can be the setting page used by the manufacturers or professionals, ordinary people is usually not allowed to access the RBSU setting interface 200.

Then, in Step S103, the hot key is registered and captured in the RBSU setting interface 200. A registration method can be performed by entering the code or directly selecting the default function preset for the hot key in the RBSU setting interface 200, so as to have the string “F12” shown in the RBSU executing interface 300, referred to FIG. 3. Then, perform the storing, and establish the screen image procedure code with respect to the captured hot key in the BIOS after the corresponding registration is done. The screen image procedure code is also the program code. Upon such an arrangement, the ability in capturing image can be enhanced.

It is worthy to note that, in the aforesaid Step S101 to Step S103, existing execution files can be directly and automatically applied. For example, the program code of the flash firmware can be performed directly so as to have the aforesaid Step S101 to Step S103 to be automatically executed while in power off the server. Namely, automatically trigger the RBSU setting procedure so as to enter the RBSU setting interface 200, also automatically register and capture the hot key, and establish automatically the screen image procedure code with respect to the captured hot key in the BIOS code. Thus, convenience in practical settings can be enhanced.

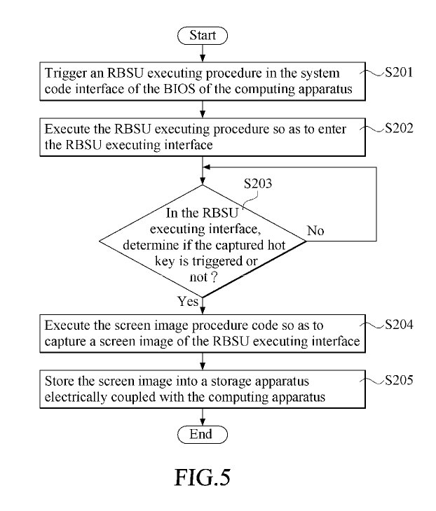

Refer now to FIG. 2 to FIG. 5, where FIG. 5 is a flowchart of the preferred method of capturing a screen image in accordance with the present invention. As shown, the method of capturing a screen image is applied to an operating computing apparatus, and is performed after the setting of the captured hot key is complete and the screen image procedure code has been added. Namely, the aforesaid Step S101 to Step S103 of FIG. 1 shall be performed firstly, and then the steps of FIG. 5 can be performed. In the present invention, the method of capturing a screen image includes the following steps.

Step S201: In the system code interface of the BIOS of the computing apparatus, trigger an RBSU executing procedure.

Step S202: Execute the RBSU executing procedure so as to enter the RBSU executing interface.

Step S203: In the RBSU executing interface, determine if the captured hot key is triggered or not.

Step S204: Execute the screen image procedure code so as to capture a screen image of the RBSU executing interface.

Step S205: Store the screen image into a storage apparatus electrically coupled with the computing apparatus.

In this embodiment, the execution of Step S201 of triggering the RBSU executing procedure is the same as that of Step S101 of triggering the RBSU setting procedure. Namely, automatic triggering or manual triggering, the setting procedures are the same (via applying the embedded application program to automatically and manually trigger the hot key. In this embodiment, the manual triggering is preferred. While in power on the apparatus, the RBSU executing procedure is performed via the trigger hot key). In Step S202, the RBSU executing interface 300 can provide relative parameters for setting and operating the server, as shown in FIG. 4.

In Step S203, under the RBSU executing interface 300, since setting of some related parameters might be necessary, the management module of the computing apparatus can keep judging if the captured hot key is triggered or not, and the management module would introduce a polling procedure to judge if the captured hot key is triggered or not. In this description, the term “keep judging” is directed to detect continuously, every second, or the like time increment per practical requirement. If the judging result of the management module is positive, then perform Step S204 directly so as to have the management module to execute directly the screen image procedure code for capturing a screen image of the RBSU executing interface 300. For example, the screen shown in FIG. 3 can be the screen image to be captured. If the captured hot key is not triggered, then the method is stalled in the RBSU executing interface 300 for the user to further perform the setting of related parameters. (Note that the hot key can only be captured after the setting is done.)

Perform Step S205 after Step S204 has been executed. In Step S205, the screen image is stored in a storage apparatus electrically coupled with the computing apparatus. Further, after the management module obtains the screen image, the screen image would be stored in the storage apparatus. In the present invention, the storage apparatus can be one of a hard disk and a USB drive. In particular, in this embodiment, the storage apparatus is a hard disk. After Step S205 is done, since the screen image has been stored, then the setting of the related parameters in the RBSU executing interface 300 can be well preserved.

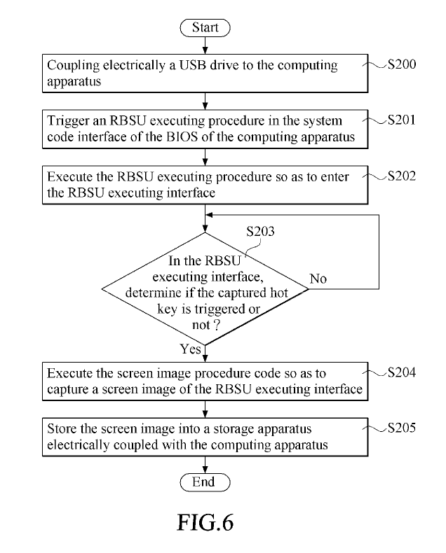

Refer now to FIG. 6, where FIG. 6 is a flowchart of another method of capturing a screen image in accordance with the present invention. As shown, the major difference between the embodiments of FIG. 5 and FIG. 6 is that the storage apparatus for the embodiment of FIG. 6 is a USB drive. Then, the method of capturing a screen image of FIG. 6 can further include a Step S200 of electrically coupling the USB drive to the computing apparatus. In practice, the method for electrically coupling the USB drive can be a manual plugging or an automatic electric coupling. It shall be noted that, for the case of plugging the USB drive into the server, electric coupling in between is actually not guaranteed. In Step S200, while the server is at the stage of power on, the USB drive would be automatically electrically coupled to the computing apparatus. However, in other embodiments, the type of electric coupling is not limited to the aforesaid style, but would be various.

In summary, by providing the method of setting a hot key and capturing a screen image, since the hot key can be captured and then set for the user to trigger in the future usage, thus the user needn't to introduce electronic devices for photographing the screen image of the RBSU executing interface. On the other hand, the screen image is directly captured by directly triggering the captured hot key. Hence, convenience in practical application is significantly improved, and also possible information leakage is substantially reduced.

While the present invention has been particularly shown and described with reference to a preferred embodiment, it will be understood by those skilled in the art that various changes in form and detail may be without departing from the spirit and scope of the present invention.

What is claimed is:

1. A method of setting a hot key for capturing a screen image, provided to operate a computing apparatus, comprising the steps of:
(a) triggering an RBSU setting procedure in a system code interface of a BIOS of the computing apparatus;
(b) executing the RBSU setting procedure so as to enter an RBSU setting interface; and
(c) registering a captured hot key in the RBSU setting interface, and establishing a screen image procedure code with respect to the captured hot key in a BIOS code of the BIOS.

2. The method of setting a hot key for capturing a screen image of claim 1, wherein the computing apparatus is one of a server and a computer.

3. The method of setting a hot key for capturing a screen image of claim 1, wherein, in the Step (a), an embedded application program of the BIOS is executed to trigger the RBSU setting procedure.

4. The method of setting a hot key for capturing a screen image of claim 1, wherein the Step (a) further includes a Step (a1) of triggering the RBSU setting procedure while the BIOS determines that a trigger hot key is triggered.

5. The method of setting a hot key for capturing a screen image of claim 4, wherein the system code interface of the BIOS has a trigger hot key procedure code corresponding to the trigger hot key so as to execute the Step (a1) of triggering the RBSU setting procedure while the trigger hot key procedure code is read.

6. A method of capturing a screen image in an RBSU executing interface by applying the method of claim 1, for operating the computing apparatus, comprising the steps of:
(a) triggering an RBSU executing procedure under the system code interface of the BIOS of the computing apparatus;
(b) executing the RBSU executing procedure so as to enter the RBSU executing interface;
(c) determining if the captured hot key is triggered or not in the RBSU executing interface;
(d) if a result of the Step (c) is positive, executing the screen image procedure code so as to capture a screen image of the RBSU executing interface; and
(e) storing the screen image into a storage apparatus electrically coupled with the computing apparatus.

7. The method of claim 6, wherein the computing apparatus is one of a server and a computer.

8. The method of claim 6, wherein the storage apparatus is one of a hard disk and a USB drive.

9. The method of claim 8, while the storage apparatus is the USB drive, prior to the Step (a), further including a Step (a0) of electrically coupling the USB drive to the computing apparatus.

10. The method of claim 6, wherein, in the Step (c), a polling procedure is used to determine if the captured hot key is triggered or not.
